(19) United States
(12) Patent Application Publication
(10) Pub. No.: US 2026/0233980 A1
(43) Pub. Date: Aug. 13, 2026

(54) WINCH MANAGEMENT SYSTEM

(71) Applicants: Scott M. Stilwell, Davidson, NC (US); Noah R. Davis, Mooresville, NC (US); Kevin J. Csehoski, Huntersville, NC (US)

(72) Inventors: Scott M. Stilwell, Davidson, NC (US); Noah R. Davis, Mooresville, NC (US); Kevin J. Csehoski, Huntersville, NC (US)

(21) Appl. No.: 19/532,238

(22) Filed: Feb. 6, 2026

Related U.S. Application Data
(60) Provisional application No. 63/755,912, filed on Feb. 7, 2025.

(51) Int. Cl. B66D 1/50; B65H 75/42; B65H 75/44

(52) U.S. Cl. CPC B66D 1/505; B65H 75/425; B65H 75/446

(57) ABSTRACT

A winch cable management system for securing a winch cable on a tow truck comprising the winch cable operationally associated with a winch and secured to a winch drum on one end and having a hook or similar device on its opposite end, a support bracket secured to the tow truck, one or more tension reels secured to the support bracket, a tension cable secured to the hook at one end and the tension reel at an opposite end, wherein the length of the tension cable extending off the tension reel adjusts in response to movement of the hook relative to the winch such that the tension cable controls the position of the hook relative to the winch and relative to the winch cable management system.

### CROSS REFERENCE TO RELATED APPLICATION

This application claims the priority of U.S. provisional patent Ser. No. 63/755,912 filed on Feb. 7, 2025. Applicant hereby incorporates by reference the entire content of provisional application Ser. No. 63/755,912.

### FIELD OF THE INVENTION

The present invention relates to a system which aids in the support and securing of winch cables. Specifically, this invention relates to the support and control of winch cables.

### BACKGROUND OF THE INVENTION

Heavy Duty tow trucks and wreckers utilize a variety of winches to aid in recovering and towing vehicles. Winch cable management is crucial for safe and efficient tow truck operations. Proper management prevents winch and cable damage, ensures smooth operation, and minimizes the risk of accidents. This involves using appropriate cable guides, tensioners, and storage solutions to keep the cable organized and prevent tangling or kinking. Regular inspection and maintenance of the cable and related components are essential to identify and address any signs of wear or damage.

Winch cable tie springs are essential components in the operation of various types of winches, particularly those used in towing and recovery. These springs serve a crucial purpose in securing the winch cable hook when it is not in use, preventing it from dangling freely and potentially causing damage or injury.

The design of winch cable tie springs is specific to their function. They are typically heavy-duty springs, capable of withstanding the stresses and strains associated with winch operation. Their size and strength are carefully calibrated to match the size and capacity of the winch they are intended for. These springs are often coated or treated to resist corrosion and wear, ensuring a long service life in demanding environments.

In addition to their practical function, winch cable tie springs also contribute to safety. By keeping the winch hook secured, they reduce the risk of accidental engagement or swinging, which could lead to property damage or personal harm. Regular inspection and maintenance of these springs are vital to ensure they remain in good working condition and continue to provide reliable service. However, issues can arise when the boom of the tow truck is extended and the springs securing the winch hook are not removed, the extended boom will draw out the winch cable, overstressing the spring which may damage the spring or break the spring, creating a hazard for both tow truck operators and bystanders.

Hence, there remains a need for a device to aid in securing, tensioning, and retaining winch cables and hooks.

### SUMMARY OF THE INVENTION

A winch cable management system for securing a winch cable on a tow truck comprising the winch cable operationally associated with a winch and secured to a winch drum on one end and having a hook or similar device on its opposite end, a support bracket secured to the tow truck, one or more tension reels secured to the support bracket, a tension cable secured to the hook at one end and the tension reel at an opposite end, wherein the length of the tension cable extending off the tension reel adjusts in response to movement of the hook relative to the winch such that the tension cable controls the position of the hook relative to the winch and relative to the winch cable management system.

### BRIEF DESCRIPTION OF THE DRAWINGS

FIG. 1 is a perspective view of the winch cable management system according to this invention and installed on a tow truck.

FIG. 2 is a perspective view of the winch cable management system according to this invention and installed on a tow truck.

FIG. 3 is a perspective view of the winch cable management system according to this invention and installed on a tow truck.

FIG. 4 is a perspective view of the winch cable management system according to this invention and installed on a tow truck.

FIG. 5 is a perspective view of the winch cable management system according to this invention.

FIG. 6 is a perspective view of the winch cable management system according to this invention.

FIG. 7A is an upper perspective view of the winch cable management system according to this invention.

FIG. 7B is a lower perspective view of the winch cable management system according to this invention.

FIG. 8A is a side view of the winch cable management system according to this invention.

FIG. 8B is a front view of the winch cable management system according to this invention.

FIG. 9 is a side view of the winch cable management system according to this invention and installed on a tow truck with the boom retracted.

FIG. 10 is a perspective view of the winch cable management system according to this invention and installed on a tow truck with the boom retracted.

FIG. 11 is a perspective view of the winch cable management system according to this invention and installed on a tow truck.

FIG. 12 is a side view of the winch cable management system according to this invention and installed on a tow truck with the boom retracted.

FIG. 13 is a side view of the winch cable management system according to this invention and installed on a tow truck with the boom retracted.

FIG. 14 is a perspective view of the winch cable management system according to this invention and installed on a tow truck with the boom extending.

FIG. 15 is a perspective view of the winch cable management system according to this invention and installed on a tow truck with the boom extending.

FIG. 16 is a side view of the winch cable management system according to this invention and installed on a tow truck with the boom extending.

FIG. 17 is a side view of the winch cable management system according to this invention and installed on a tow truck with the boom retracted.

FIG. 18 is a side view of the winch cable management system according to this invention and installed on a tow truck with the boom retracted.

FIG. 19 is a perspective view of a support bracket component of the inch cable management system according to this invention.

FIG. 20 is a side view of a support bracket component of the winch cable management system according to this invention.

FIG. 21 is a side view of a support bracket component of the winch cable management system according to this invention.

FIG. 22 is a rear view of a support bracket component of the winch cable management system according to this invention.

FIG. 23 is a front view of a support bracket component of the winch cable management system according to this invention.

FIG. 24 is a perspective view of the winch cable management system according to this invention.

FIG. 25 is a perspective view of the assembled winch cable management system according to this invention.

FIG. 26 is a perspective view of the winch cable management system according to this invention and installed on a tow truck with the boom retracted.

FIG. 27 is a perspective view of the winch cable management system according to this invention and installed on a tow truck with the boom extended.

FIG. 28 is a perspective view of the winch cable management system according to this invention and installed on a tow truck with the boom retracted.

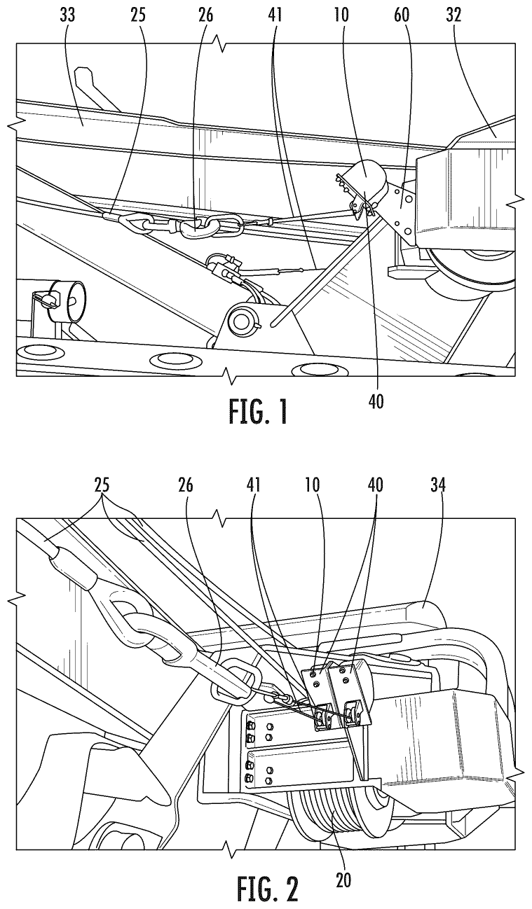

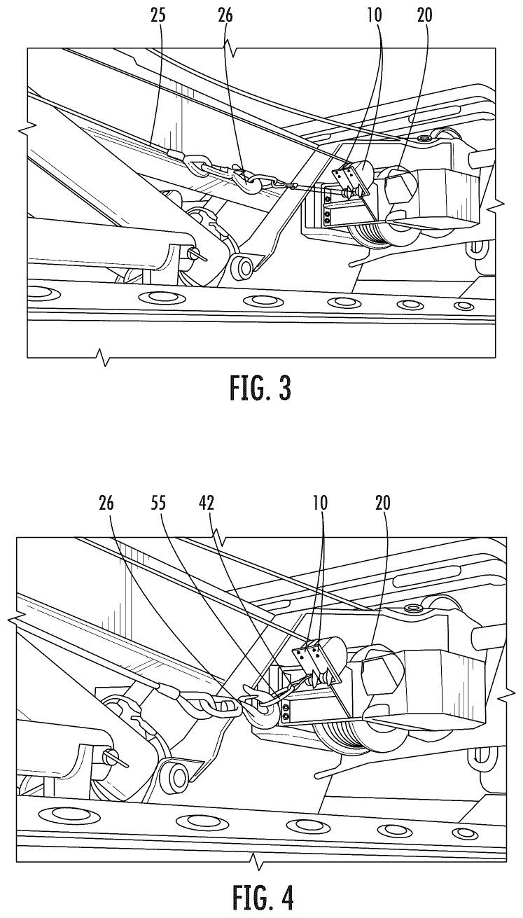

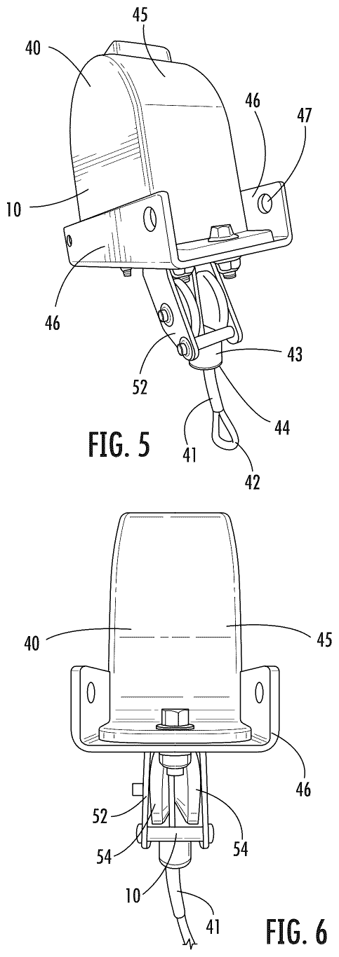

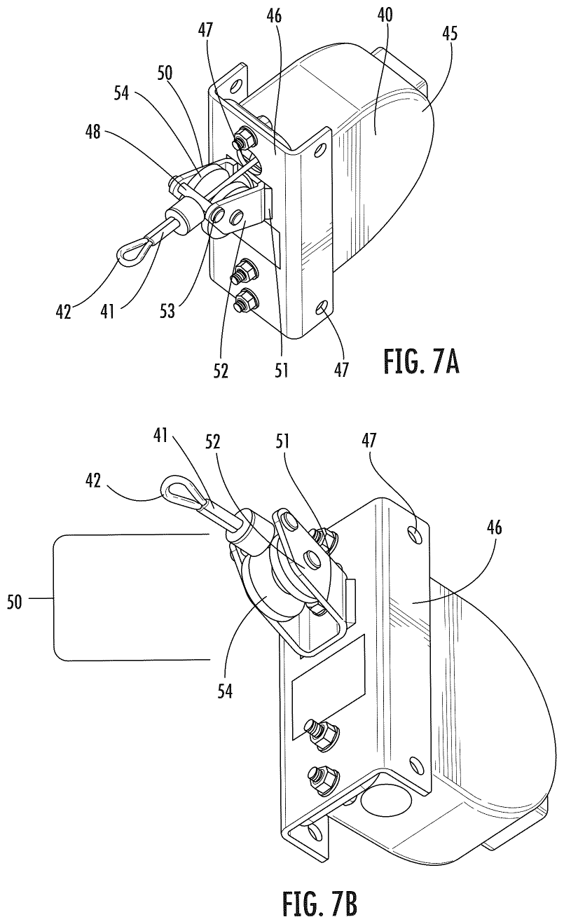

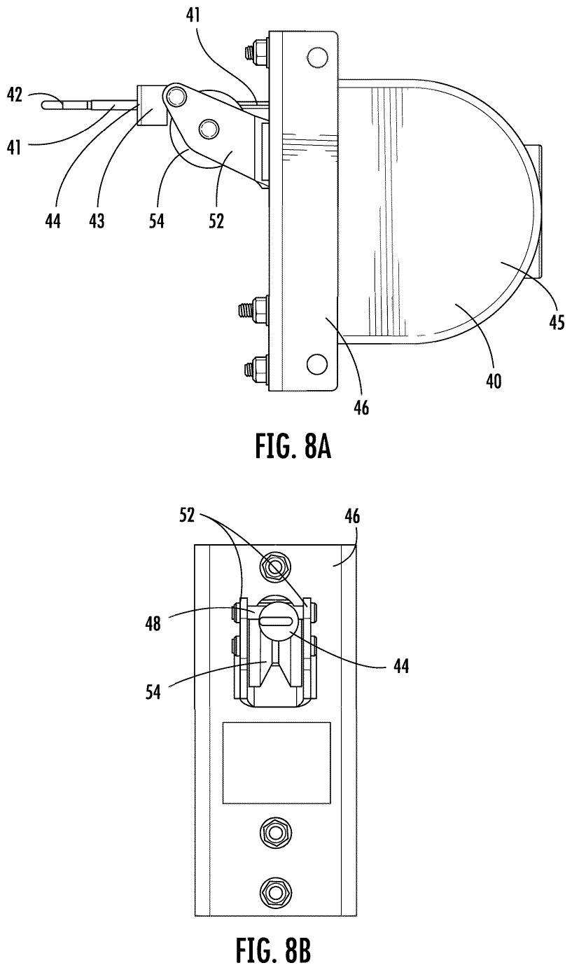

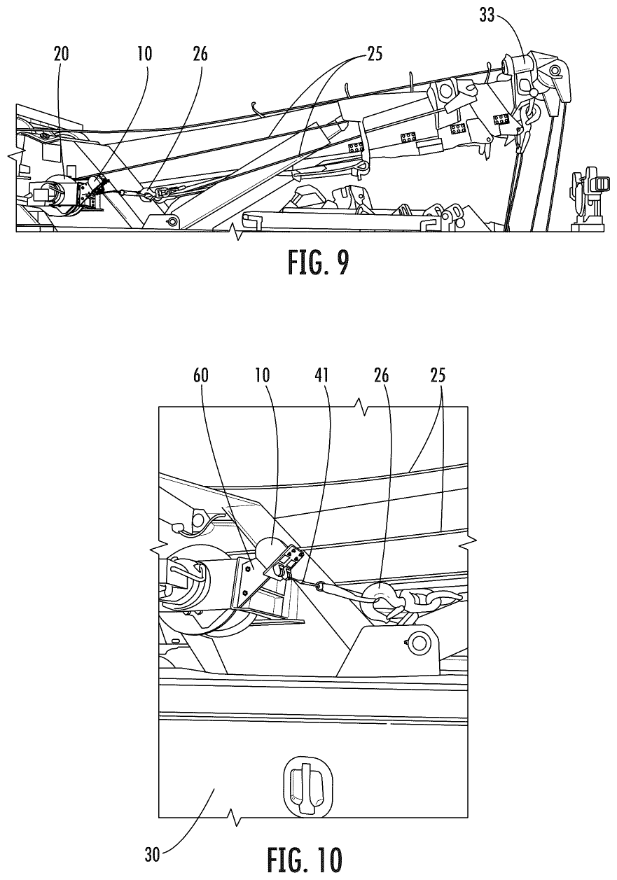

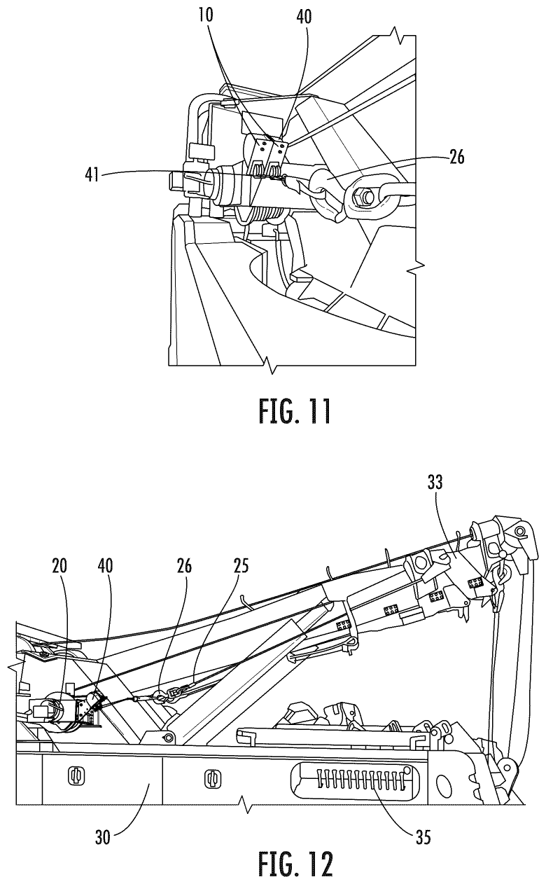

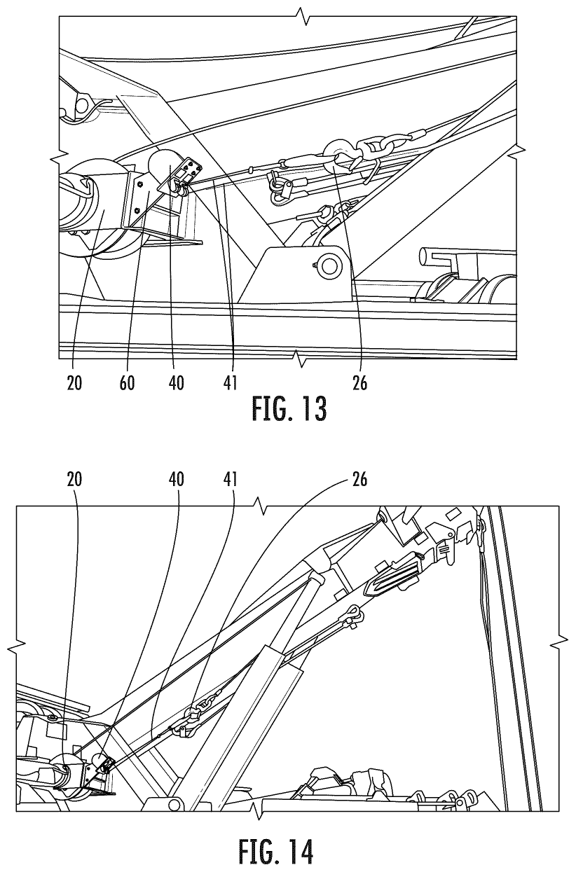

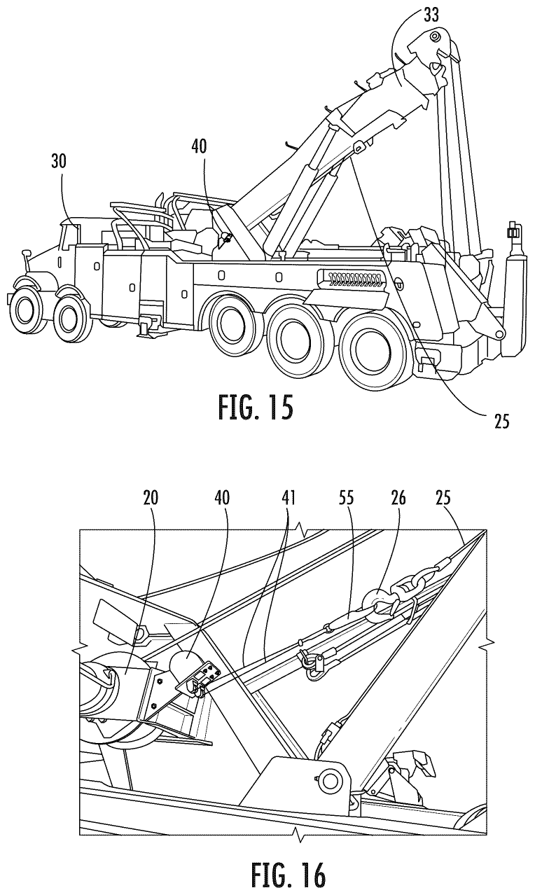

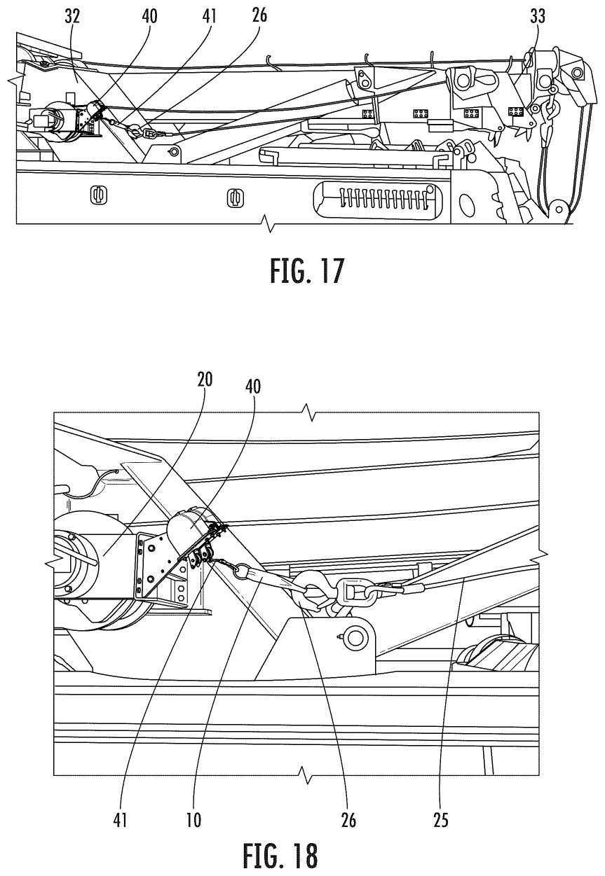

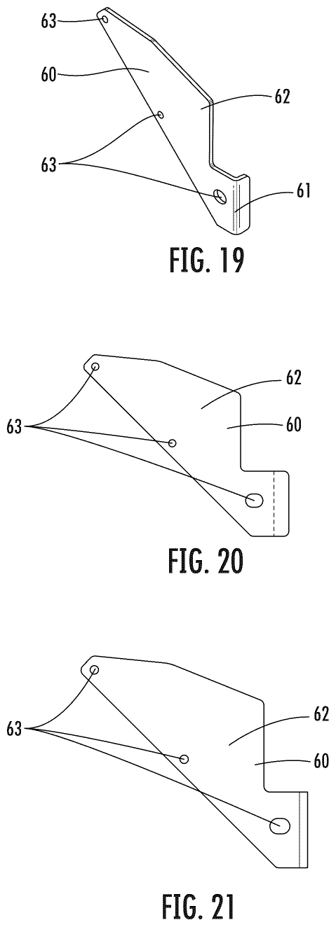

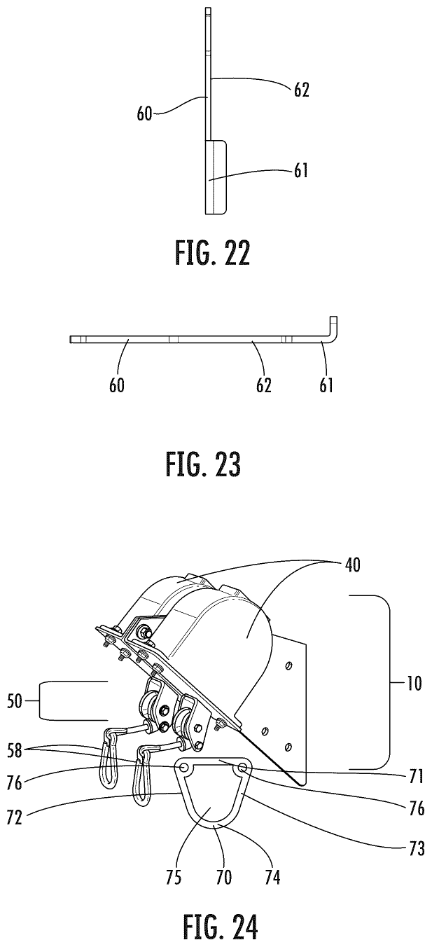

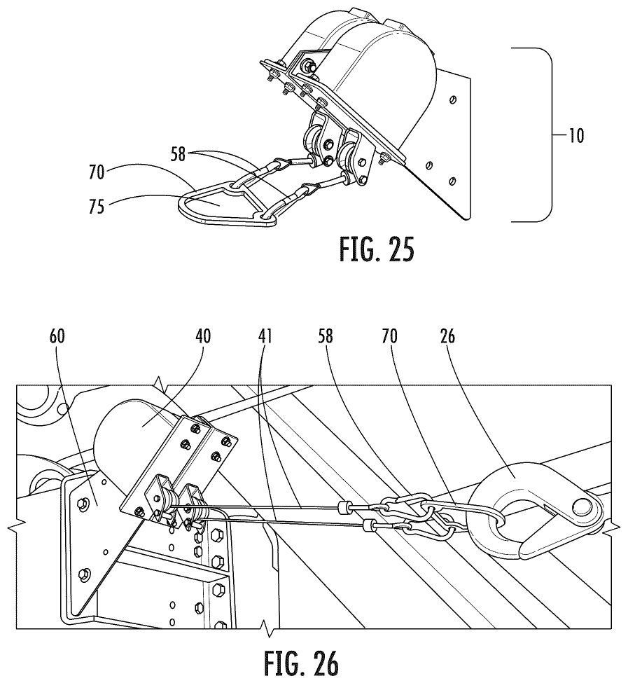

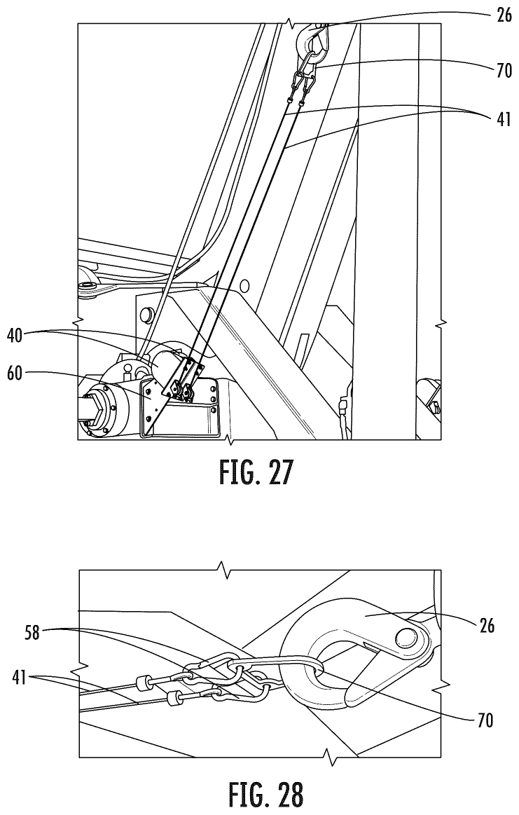

### DETAILED DESCRIPTION OF THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the present disclosure. In addition, descriptions of well-known functions and constructions may be omitted for clarity and conciseness.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents. Depending on the context of the sentence, the reading of this patent specification should be done with the same concept as “reject the absurd”, wherein if possible, a specification should be construed so as not to lead to a foolish result or one which the patentee could not have contemplated.

It is to be understood that the singular forms “a”, “an,” and “the” include plural referents unless the context clearly dictates otherwise. Thus, for example, reference to “a spring” includes reference to one or more of such springs.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present invention addresses the need for a device to aid in the management of tow truck winch cables to prevent undue strain, premature wear, damage, injury, and failure. To address these issues, a winch cable management system 10 for securing a winch cable 25 on a tow truck 30 was developed. Generally speaking, tow trucks 30 include a cab and a bed. A base 32 of an extendable boom 33 is located in the bed of the tow truck as are the light frame and controls 35 for the boom and various winches. The winch cable management system 10 includes a winch cable 25 operationally associated with a winch 20 and secured to a winch drum on one end and having a hook 26 or similar device on its opposite end. A support bracket 60 is secured to the tow truck 30, one or more tension reels 40 secured to the support bracket 60, a tension cable 41 is secured to the hook 26 at one end and the tension reel 40 at an opposite end, wherein the length of the tension cable 41 extending off the tension reel 40 adjusts in response to movement of the hook 26 relative to the winch 20 and relative to the tension reels 40 such that the tension cable 41 controls the position of the hook 26 relative to the winch 20 and relative to the tension reels 40.

In another embodiment, the winch cable management system 10 for securing a winch cable 25 on a tow truck 30 comprises a support bracket 60 secured to the tow truck 30, one or more tension reels 40 secured to the support bracket 60, a tension cable 41 secured to each tension reel 40 at one end and secured to a hook 26 at an opposite end, wherein the hook 26 is secured to a winch cable 25 which is operationally associated with and secured to a winch drum on the tow truck 30, and wherein a length of the tension cable 41 extending off the tension reel 40 adjusts in response to movement of the hook 26 relative to the tension reel 40 such that the tension cable 41 controls a position of the hook 26 relative to the tension reel 40.

The winch cable management system 10 can further include a mounting bracket 46 secured to each of the one or more tension reels 40. The mounting bracket 46 can include an aperture 47 through which the tension cable 41 passes from the tension reel 40. A housing 45 surrounds the tension reel 40, protecting it from the elements and physical damage. The housing 45 includes an opening through which the tension cable 41 extends from or retracts onto the tension reel 40 as the tension cable travels through the mounting bracket 46 in response to movement of the hook 26 and winch cable 25. A roller assembly 50 is secured to the mounting bracket 46, the roller assembly including a base 51, a pair of roller brackets 52 secured to the base 51 creating a channel, an axle secured between the pair of roller brackets 52, a roller 54 rotatably mounted to the axle, and a axle 48 secured around the pair of roller brackets 52, wherein the tension cable 41 rides on the roller 54 and passes between the roller and the axle. The roller brackets 52 are generally parallel to one another and extend perpendicularly from the base 51. The axle 48 extends across the roller 54 and is mounted at each axle end 53 to a roller bracket 52, securing an open space between the roller and the axle to maintain the tension cable 41 in alignment with the roller 54. The roller assembly 50 is designed and configured to maintain proper alignment of the tension cable 41 resulting from inward or outward movement of the tension cable as it travels across the roller 54 through the aperture 47 of the mounting bracket 46 onto the tension reel 40 within the housing 45. The tension cable 41 can be secured to the hook 26 at the end of the winch cable 25 using a shackle 55, a clip or carabiner 58, a connect clip 70, or similar device, or a combination thereof, to connect a hook, carabiner, or similar device secured to the attachment loop 42 located at the end of each tension cable 41. The mounting bracket can be any shape known to function within the industry including, but not limited to, “U” shaped.

The winch cable management system 10 can further include an attachment loop 42 located on the tension cable 41, a stopper 43 secured around the tension cable 41 adjacent to the attachment loop 42, and a washer 44 secured around the tension cable 41 between the stopper 43 and the attachment loop 42. The stopper it generally made of an elastic material, such a rubber or nylon, and the winch cable passes through the stopper (as shown in the figures). The washer 44 was added to prevent the end of the attachment loop 42 of the tension cable 41 from being pulled through the stopper when the tension cable is retracted into the tension reel 40.

The winch cable management system 10 can include an attachment loop 42 located on the tension cable 41 at the same end secured to the hook 26, a stopper 43 secured around the tension cable 41 adjacent to the attachment loop 42, and a washer 44 secured around the tension cable 41 between the stopper 43 and the attachment loop 42. The winch cable management system 10 can include a variety of connectors to aid in releasably securing each tension cable 41 to one of the hooks 26 on a vehicle. These connectors include a shackle 55, a clip/carabiner 58 or any other connector known in the art which possesses the strength required to maintain tension on a winch cable 25 without damage or breakage. In one embodiment, a clip/carabiner 58 is secured to each tension cable, generally at an attachment loop 42, a connection clip 70 is secured to the clip/carabiner 58, and the hook 26 secured to the connection clip 70.

One embodiment of the instant invention includes a winch cable management system 10 for securing a winch cable 25 on a tow truck 30 comprising, a support bracket 60 secured to the tow truck 30, one or more tension reels 40 secured to the support bracket 60, a tension cable 41 secured to each tension reel 40 at one end and having an attachment loop 42 on an opposite end. A shackle 55, a clip/carabiner 58, or a combination thereof is secured to the attachment loop 42, wherein a hook 26 is secured to a winch cable 25 which is operationally associated with and secured to a winch drum on the tow truck 30, wherein the hook is releasably secured to the shackle 55, the clip/carabiner 58, or a combination thereof, wherein a length of the tension cable 41 extending off the tension reel 40 adjusts in response to movement of the hook 26 relative to the tension reel 40 such that the tension cable 41 controls a position of the hook 26 relative to the tension reel 40.

One embodiment of the instant invention includes a winch cable management system 10 for securing a winch cable 25 on a tow truck 30 comprising the winch cable 25 operationally associated with a winch 20 and secured to a winch drum on one end and having a hook 26 or similar device on its opposite end, a support bracket 60 secured to the tow truck 30, one or more tension reels 40 secured to the support bracket 60, a tension cable 41 secured to each tension reel 40 at one end and having an attachment loop 42 on an opposite end. A shackle 55, a clip/carabiner 58, or a combination thereof is secured to the attachment loop 42 and the hook 26, wherein a length of the tension cable 41 extending off each tension reel 40 adjusts in response to movement of the hook 26 relative to the winch 20 and relative to the tension reel(s) 40 such that the tension cable 41 controls a position of the hook 26 relative to the winch 20 and the tension reel(s) 40.

The winch cable management system 10 uses the tension cable 41 to maintain a relatively constant tension on the winch cable 25 while a boom 33 on the tow truck 30 is extended and/or retracted. The length of the tension cable 41 extending off the tension reel 40 increases as the boom 33 on the tow truck 30 is extended, still maintaining tension on the winch cable 25 and the length of the tension cable 41 extending off the tension reel 40 decreases as the boom 33 on the tow truck 30 is retracted, still maintaining tension on the winch cable 25.

A tow truck can be equipped with an individual winch cable management system 10 for each individual winch cable 25 mounted and/or operationally associated with the tow truck. The winch cable management system 10 enables simple and easy disconnection of the winch system directly from the ground, instead of having to climb up on the tow truck, which significantly reduces the risk of a slip/fall or other injury. Additionally, the system 10 eliminates the need to free-wheel the winch 20 when raising the boom 33 of the truck. This often causes backlash, also known as “bird nesting”, of the winch cable 25 on the winch when the winch cable gets tangled around the winch drum (like a bait cast fishing reel).

The instant invention also includes a method for managing a winch cable 25 on a tow truck 30 comprising the steps of:
a) providing a winch cable management system 10 for securing the winch cable 25 on a tow truck 30 comprising:
   a support bracket 60 secured to the tow truck 30;
   one or more tension reels 40 secured to the support bracket 60;
   a tension cable 41 secured to one tension reel 40 at one end and having an attachment loop 42 on an opposite end;
      wherein a hook 26 is secured to an end of the winch cable 25 which is operationally associated with and secured to a winch drum on the tow truck 30;
b) securing the hook 26 to the attachment loop 42; and
c) controlling a position of the hook 26 relative to the winch 20 and to the tension reel 40 by allowing a length of the tension cable 41 extending off the tension reel 40 to adjust in response to movement of the hook 26 relative to the winch 20 and the tension reel 40.

Any method described herein may incorporate any design element contained within this application and any other document/application incorporated by reference herein.

To the accomplishment of the foregoing and related ends, one or more various embodiments include the features hereinafter fully described and particularly pointed out in the claims. The following description and the annexed drawings set forth in detail certain illustrative aspects and are indicative of but a few of the various ways in which the principles of the various embodiments may be employed. Other advantages and novel features will become apparent from the following detailed description when considered in conjunction with the drawings and the disclosed various embodiments are intended to include all such aspects and their equivalents.

Other aspects, advantages, and salient features of the disclosure will become apparent to those skilled in the art from the following detailed description, which, taken in conjunction with the annexed drawings, discloses various embodiments of the present disclosure.

While the present disclosure has been shown, and described with reference to various embodiments thereof, it will be understood by those ordinary skilled in the art that various changes in form and details may be made therein without departing from the scope of the present disclosure as defined by the appended claims and their equivalents.

What is claimed:

1. A winch cable management system 10 for securing a winch cable 25 on a tow truck 30 comprising:
a support bracket 60 secured to the tow truck 30;
one or more tension reels 40 secured to the support bracket 60;
a tension cable 41 secured to one said tension reel 40 at one end and secured to a hook 26 at an opposite end;
wherein said hook 26 is secured to a winch cable 25 which is operationally associated with and secured to a winch drum on said tow truck 30; and
wherein a length of said tension cable 41 extending off said tension reel 40 adjusts in response to movement of the hook 26 relative to the tension reel 40 such that said tension cable 41 controls a position of the hook 26 relative to said tension reel 40.

2. The winch cable management system 10 of claim 1, wherein
said tension cable 41 maintains a relatively constant tension on the winch cable 25 while a boom 33 on the tow truck 30 is extended and/or retracted.

3. The winch cable management system 10 of claim 1 wherein
the length of said tension cable 41 extending off said tension reel 40 increases as a boom 33 on the tow truck 30 is extended, still maintaining tension on the winch cable 25; and
the length of said tension cable 41 extending off said tension reel 40 decreases as the boom 33 on the tow truck 30 is retracted, still maintaining tension on the winch cable 25.

4. The winch cable management system 10 of claim 1 further comprising:
a mounting bracket 46 secured to each of the one or more tension reels 40;
a roller assembly 50 secured to the mounting bracket 46, the roller assembly including:
a base 51;
a pair of roller brackets 52 secured to the base 51 creating a channel;
an axle secured between the pair of roller brackets 52;
a roller 54 rotatably mounted to the axle; and
a axle 48 secured around the pair of roller brackets 52;
wherein the tension cable 41 rides on the roller 54 and passes between the roller and the axle.

5. The winch cable management system 10 of claim 4, wherein
the mounting bracket 46 is “U” shaped.

6. The winch cable management system 10 of claim 1 further comprising:
an attachment loop 42 located on the tension cable 41 at the same end secured to said hook 26;
a stopper 43 secured around the tension cable 41 adjacent to the attachment loop 42; and
a washer 44 secured around the tension cable 41 between the stopper 43 and the attachment loop 42.

7. The winch cable management system 10 of claim 6 further comprising:
a shackle 55 or a clip/carabiner 58 secured to said attachment loop 42;
a connection clip 60 secured to said shackle 55 or clip/carabiner 58; and
said hook 26 secured to said connection clip 60.

8. A tow truck with one or more winch cables mounted thereon and a winch cable management system 10 as described in claim 1 operationally associated with each of the one or more winch cables.

9. A method for managing a winch cable 25 on a tow truck 30 comprising the steps of:
providing a winch cable management system 10 for securing the winch cable 25 on a tow truck 30 comprising:
a support bracket 60 secured to the tow truck 30;
one or more tension reels 40 secured to the support bracket 60;
a tension cable 41 secured to one said tension reel 40 at one end and having an attachment loop 42 on an opposite end;
wherein a hook 26 is secured to an end of said winch cable 25 which is operationally associated with and secured to a winch drum on said tow truck 30;
securing the hook 26 to the attachment loop 42; and
controlling a position of the hook 26 relative to said winch 20 and to said tension reel 40 by allowing a length of said tension cable 41 extending off said tension reel 40 to adjust in response to movement of the hook 26 relative to the winch 20 and the tension reel 40.

10. The method of claim 9, wherein
said tension cable 41 maintains a relatively constant tension on the winch cable 25 while a boom 33 on the tow truck 30 is extended and/or retracted.

11. The method of claim 9 wherein
the length of said tension cable 41 extending off said tension reel 40 increases as a boom 33 on the tow truck 30 is extended, still maintaining tension on the winch cable 25; and
the length of said tension cable 41 extending off said tension reel 40 decreases as the boom 33 on the tow truck 30 is retracted, still maintaining tension on the winch cable 25.

12. The method of claim 9 further comprising:
a mounting bracket 46 secured to each of the one or more tension reels 40;
a roller assembly 50 secured to the mounting bracket 46, the roller assembly including:
a base 51;
a pair of roller brackets 52 secured to the base 51 creating a channel;
an axle secured between the pair of roller brackets 52;
a roller 54 rotatably mounted to the axle; and
a axle 48 secured around the pair of roller brackets 52;
wherein the tension cable 41 rides on the roller 54 and passes between the roller and the axle.

13. The method of claim 12, wherein the mounting bracket 46 is “U” shaped.

14. The method of claim 9 further comprising:
a stopper 43 secured around the tension cable 41 adjacent to the attachment loop 42; and
a washer 44 secured around the tension cable 41 between the stopper 43 and the attachment loop 42.

15. The method of claim 9 further comprising:
a shackle 55 or a clip/carabiner 58 secured to said attachment loop 42;
a connection clip 70 secured to said shackle 55 or clip/carabiner 58; and
said hook 26 secured to said connection clip 70.

16. A winch cable management system 10 for securing a winch cable 25 on a tow truck 30 comprising:
a support bracket 60 secured to the tow truck 30;
one or more tension reels 40 secured to the support bracket 60;
a tension cable 41 secured to each said tension reel 40 at one end and having an attachment loop 42 on an opposite end;
a shackle 55, a clip/carabiner 58, or a combination thereof is secured to said attachment loop 42;
wherein a hook 26 is secured to a winch cable 25 which is operationally associated with and secured to a winch drum on said tow truck 30;
wherein said hook is releasably secured to said shackle 55, said clip/carabiner 58, or a combination thereof;
wherein a length of said tension cable 41 extending off said tension reel 40 adjusts in response to movement of the hook 26 relative to the tension reel 40 such that said tension cable 41 controls a position of the hook 26 relative to said tension reel 40.

17. The winch cable management system 10 of claim 16, wherein
said tension cable 41 maintains a relatively constant tension on the winch cable 25 while a boom 33 on the tow truck 30 is extended and/or retracted.

18. The winch cable management system 10 of claim 16 wherein
the length of said tension cable 41 extending off said tension reel 40 increases as a boom 33 on the tow truck 30 is extended, still maintaining tension on the winch cable 25; and
the length of said tension cable 41 extending off said tension reel 40 decreases as the boom 33 on the tow truck 30 is retracted, still maintaining tension on the winch cable 25.

19. The winch cable management system 10 of claim 16 further comprising:
a mounting bracket 46 secured to each of the one or more tension reels 40;
a roller assembly 50 secured to the mounting bracket 46, the roller assembly including:
a base 51;
a pair of roller brackets 52 secured to the base 51 creating a channel;
an axle secured between the pair of roller brackets 52;
a roller 54 rotatably mounted to the axle; and
a axle 48 secured around the pair of roller brackets 52;
wherein the tension cable 41 rides on the roller 54 and passes between the roller and the axle.

20. A tow truck with one or more winch cables mounted thereon and a winch cable management system 10 as described in claim 16 operationally associated with each of the one or more winch cables.
